(19) United States
(12) Patent Application Publication
(10) Pub. No.: US 2010/0083582 A1
(43) Pub. Date: Apr. 8, 2010

(54) STRUCTURE TO BE ATTACHED TO A WINDOW FRAME

(76) Inventor: Tuan A. Tran, Atlanta, GA (US)

Correspondence Address: INTELLECTUAL PROPERTY, ALCOA TECHNICAL CENTER, BUILDING C, 100 TECHNICAL DRIVE, ALCOA CENTER, PA, 15069-0001, US

(21) Appl. No.: 12/246,650

(22) Filed: Oct. 7, 2008

(51) Int. Cl. E06B 1/36; E06B 1/26

(52) U.S. Cl. 49/504

(57) ABSTRACT

A structure having a first member of the structure having a first end and a second end; and a second member having a front side, a back sides, a first end, a second end, a first leg, and a second leg; wherein the first end of the first member is perpendicularly connected to the back side of the second member; wherein the first leg extends from the front side of the second member in a vicinity of the first end of the said second member and has a mating protrusion on its distal end; wherein the second leg extends from the front side of the second member in a vicinity of the second end of the said second member and has a mating protrusion on its distal end; and wherein the mating protrusions of the first leg and the second leg of the second member mate with a surface of a side of a window frame to create a barrier between the window frame and a building structure.

### BACKGROUND OF THE INVENTION

Anchoring of a window to a building structure is usually accomplished by attaching a window frame directly to the building structure or by attaching the window frame to strap anchors incorporated in the building structure. Both methods usually require strenuous overhead drilling and are impeded by sometimes awkward positioning of anchoring surfaces. Labor expense increases even more when installing aluminum windows. Further, in a typical anchoring, the interior part of a window remains poorly insulated from the outside environment due to either surface-to-surface anchoring imperfections or conductivity of environmental factors from the building structure to the window.

After mechanical anchoring is accomplished, often, resulting seams and remaining voids between the window and the building structure are caulked in attempt to protect against environmental factors entering or being conducted inside the building structure though window frames. Caulking, due to weathering or imperfect application techniques, may significantly lower the esthetic effect of the building structure. Any structure which facilitates the process of anchoring windows to the building structure, and, at the same time, lowers entry or conductivity of environmental factors inside the building structure through window frames, and, at the same time, preserves the esthetic appeal of the building structure, would be of significant utility for construction industry. Prior approaches directed toward such a desirable objective have included variations in window design and strap anchors, as well as external flanges incorporated between subsiding and sidings and covering seams between anchored windows and the building structure.

### BRIEF SUMMARY OF THE INVENTION

A structure to be attached to a window frame is disclosed herein, the disclosed structure facilitates the process of anchoring windows to a building structure, and, at the same time, lowers entry or conductivity of environmental factors inside the building structure through window frames, and, at the same time, preserves the esthetic appeal of the building structure.

According to one embodiment of the present invention, the disclosed structure having a first member of the structure having a first end and a second end; and a second member having a front side, a back sides, a first end, a second end, a first leg, and a second leg; wherein the first end of the first member is perpendicularly connected to the back side of the second member; wherein the first leg extends from the front side of the second member in a vicinity of the first end of the said second member and has a mating protrusion on its distal end; wherein the second leg extends from the front side of the second member in a vicinity of the second end of the said second member and has a mating protrusion on its distal end; and wherein the mating protrusions of the first leg and the second leg of the second member mate with a surface of a side of a window frame to create a barrier between the window frame and a building structure. In an embodiment, the first member connects to the second member at the first or the second end of the second member. In an embodiment, the first member is situated between the first and second ends of the second member.

In an embodiment, the mating protrusions of the first leg and the second leg of the second member have hook-like endings and wherein the hook-line endings of the first and second legs of the second member mate with corresponding hook-like members of the window frame.

In an embodiment, the window frame has the structure attached to more than one side of the window frame. In an embodiment, the structure is made of plastic material. In an embodiment, the structure is made of non-temperature conductive material.

For the purposes of describing and claiming the present invention, the following terms are defined.

“Plastic materials” mean a synthetic or semisynthetic organic solid materials. Examples of suitable plastic materials may include polyolefins such as polypropylene and polyethylene, polyisoprene, polybutadiene, polybutene, polysiloxane, polycarbonates, polyamides, ethylene-vinyl acetate copolymers, ethylene-methacrylate copolymer, poly(vinyl chloride), polystyrene, polyesters, polyanhydrides, polyacrylianitrile, polysulfones, polyacrylic ester, acrylic, polyurethane and polyacetal, or copolymers or mixtures thereof.

“Non-temperature conductive materials” means materials which relatively non-temperature conductive materials. Such non-temperature conductive materials may include plastic materials.

### BRIEF DESCRIPTION OF THE SEVERAL VIEWS OF THE DRAWINGS

The present invention will be further explained with reference to the attached drawings, wherein like structures are referred to by like numerals throughout the several views. The drawings shown are not necessarily to scale, with emphasis instead generally being placed upon illustrating the principles of the present invention.

FIGS. 1A, 1B and 1C depict one embodiment of the claimed invention.

FIGS. 2A, 2B and 2C depict another embodiment of the claimed invention.

FIG. 3 depict a top view of an embodiment of the claimed invention attached to a window frame.

FIG. 4 depict a top view of an embodiment of the claimed invention attached to a window frame.

FIG. 5 depicts another embodiment of the claimed invention.

FIG. 6 depicts yet another embodiment of the claimed invention.

FIG. 7 depicts an embodiment of the claimed invention.

### DETAILED DESCRIPTION OF THE INVENTION

Detailed embodiments of the present invention are disclosed herein; however, it is to be understood that the disclosed embodiments are merely illustrative of the invention that may be embodied in various forms. In addition, each of the examples given in connection with the various embodiments of the invention are intended to be illustrative, and not restrictive. Further, the figures are not necessarily to scale, some features may be exaggerated to show details of particular components. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention.

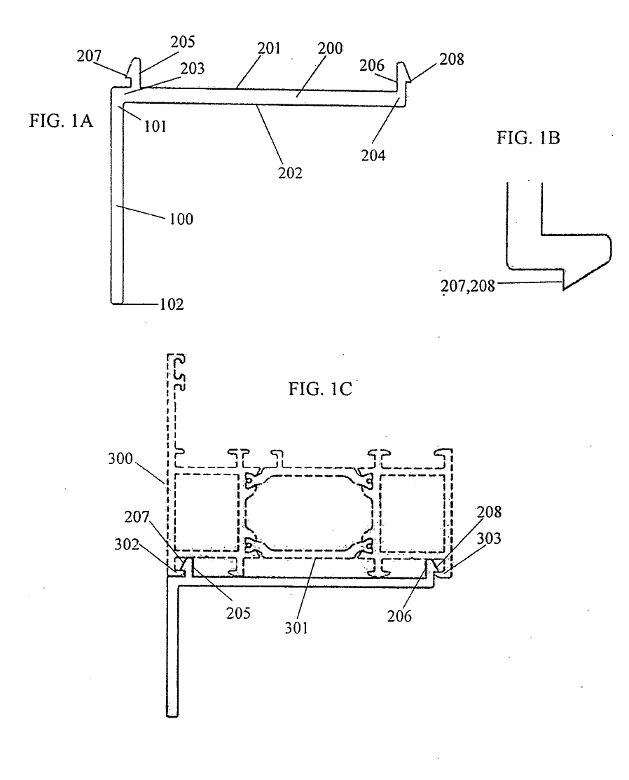

FIGS. 1A, 1B and 1C show one embodiment of the claimed invention. In FIG. 1A, a structure to be attached to a window frame comprises of a first member 100 having a first end 101 and a second end 102; and a second member 200 having a front side 201, a back side 202, a first end 203, a second end 204, a first leg 205, and a second leg 206. The first end 101 of the first member 100 is perpendicularly connected to the back side 202 of the second member 200 at the first end 203. The first leg 205 of the second member 200 extends from the front side 201 of the second member in a vicinity of the first end 203 of the said second member and has a mating protrusion 207 on its distal end. The second leg 206 of the second member 200 also extends from the front side 201 of the second member in a vicinity of the second end 204 of the said second member and has a mating protrusion 208 on its distal end. FIG. 1B shows an enlarged drawing of a leg (205, 206) of the second member 200 having a mating protrusion (207, 208). As shown in FIG. 1C, the mating protrusion 207 of the first leg 205 and the mating protrusion 208 of the second leg 206 of the second member 200 mate with a surface of a side 301 of a window frame 300, attaching the structure to the window frame.

In an embodiment, as shown in FIG. 1B, mating protrusions, 207 and 208, may have a hook-like ending. As show in FIG. 1C, 207 and 208 hook-like endings of the mating protrusions mate with corresponding hook-like members, 302 and 303 in FIG. 1B, of the window frame 300, attaching the structure to the window frame.

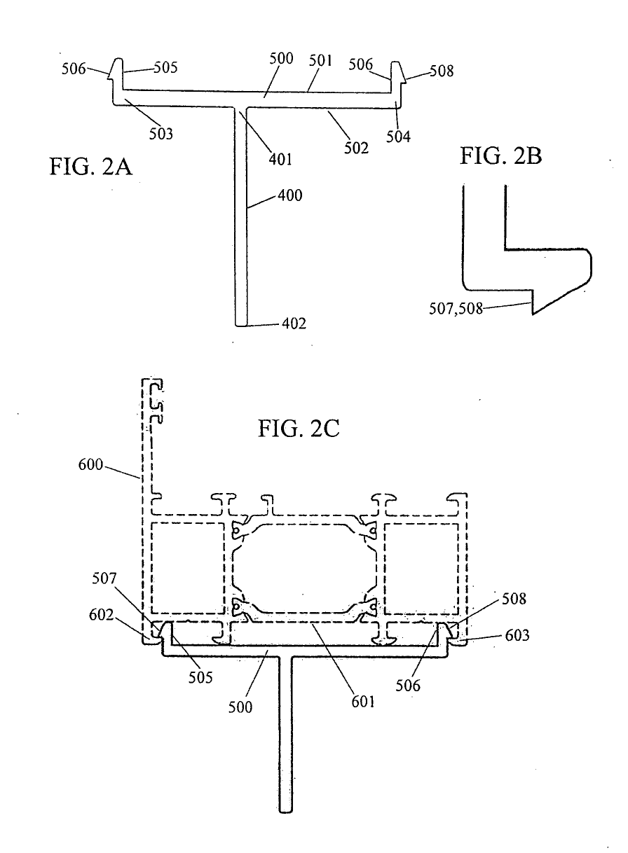

FIGS. 2A, 2B and 2C show another embodiment of the claimed invention. In FIG. 2A, a structure to be attached to a window frame comprises of a first member 400 having a first end 401 and a second end 402; and a second member 500 having a front side 501, a back side 502, a first end 503, a second end 504, a first leg 505, and a second leg 506. The first end 401 of the first member 400 is perpendicularly connected to the back side 502 of the second member 500 and is situated between the first 503 and the second 504 ends of the second member 500. The first leg 505 of the second member 500 extends from the front side 501 of the second member in a vicinity of the first end 503 of the said second member and has a mating protrusion 507 on its distal end. The second leg 506 of the second member 500 also extends from the front side 501 of the second member in a vicinity of the second end 504 of the said second member and has a mating protrusion 508 on its distal end. FIG. 2B shows an enlarged drawing of a leg (505, 506) of the second member 500 having a mating protrusion (507, 508). As shown in FIG. 2C, the mating protrusion 507 of the first leg 505 and the mating protrusion 508 of the second leg 506 of the second member 500 mate with a surface of a side 601 of a window frame 600, attaching the structure to the window frame.

In an embodiment, as shown in FIG. 2B, mating protrusions, 507 and 508, may have a hook-like ending. As show in FIG. 2C, 507 and 508 hook-like endings of the mating protrusions mate with corresponding hook-like members (602, 603) of the window frame 600, attaching the structure to the window frame.

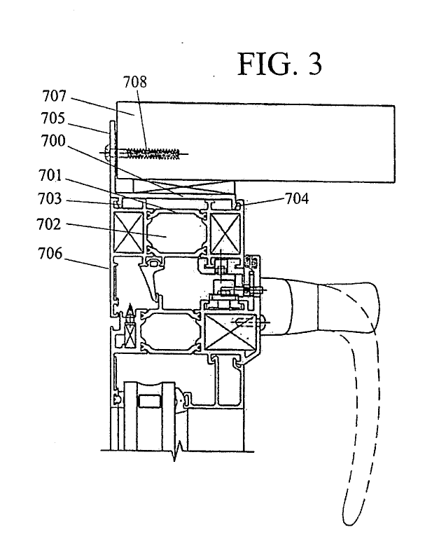

FIG. 3 shows one embodiment of the claimed structure 700 to be attached to a side 701 of a window frame 702 of a window anchored in a building structure 707. Mating protrusions (703, 704) on legs of the second member attach the structure 700 to the window frame 702. The first member 705 is flash with a face 706 of the window frame 702 and extends over a portion of a building structure 707, framing the window opening. The first member 705 could be further secured to a building structure 707 in various ways, such as using screws or nails 708.

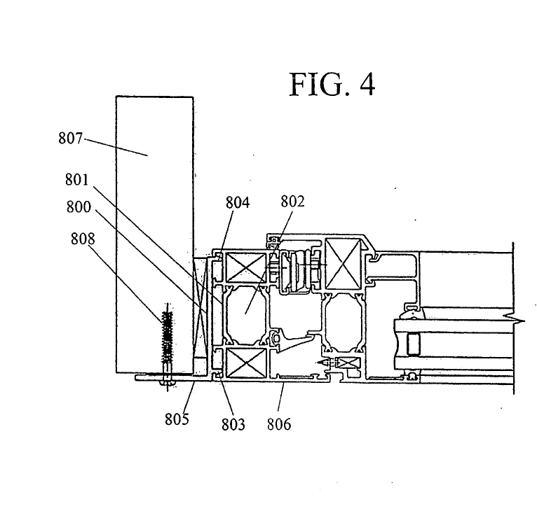

FIG. 4 shows one embodiment of the claimed structure 800 to be attached to a side 801 of a window frame 802 of a window anchored in a building structure 807. Mating protrusions 803 and 804 on legs of the second member attach the structure 800 to the window frame 802. The first member 805 is flash with a face 806 of the window frame 802 and extends over a portion of a building structure 807, framing the window opening. The first member 805 could be further secured to a building structure 807 in various ways, such as using screws or nails 808.

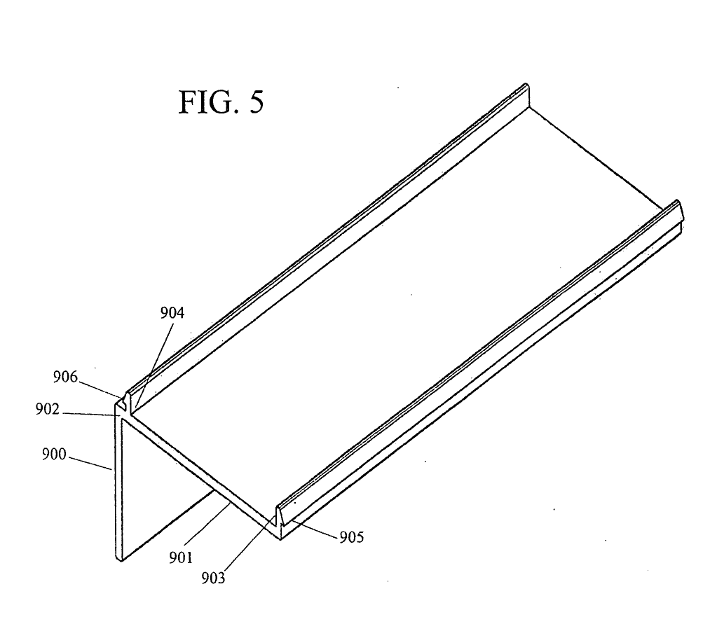

FIG. 5 shows another embodiment of the claimed structure; wherein the first member 900 of the structure is perpendicularly connected to the second member 901 at a first end 903 of the second member 901. Mating protrusions (905, 906) on legs (903, 904) of the second member 901 serve to attach the claimed structure to a window frame.

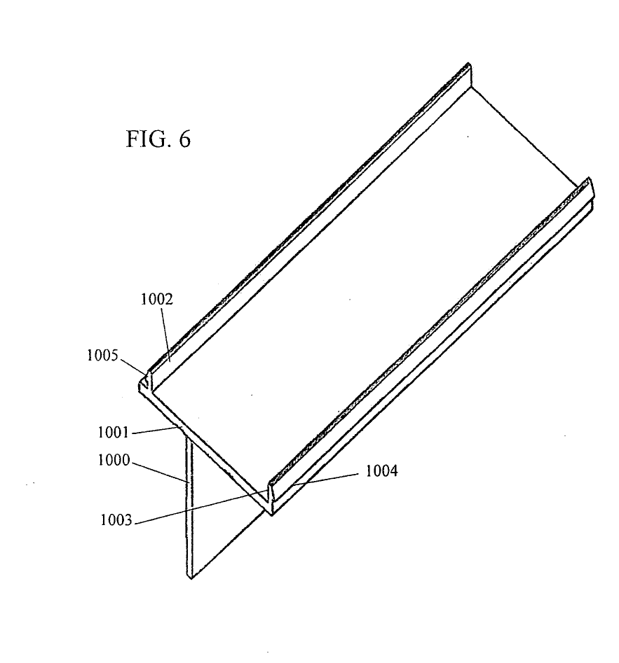

FIG. 6 shows another embodiment of the claimed structure; wherein the first member 1000 of the structure is perpendicularly connected to the second member 1001. Mating protrusions (1004, 1005) on legs (1002, 1003) of the second member 1001 serve to attach the claimed structure to a window frame.

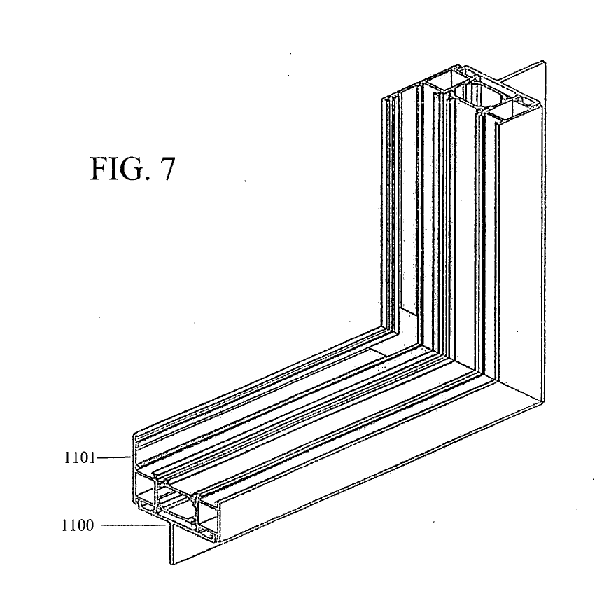

FIG. 7 shows an embodiment, in which the structure 1100 is attached to more than one side of the window frame 1101.

In an embodiment, the structure could be made of plastic material.

In an embodiment, the structure could be made of non-temperature conductive material.

What is claimed is:

1. A structure, comprising:
a first member having a first end and a second end;
a second member having a front side, a back sides, a first end, a second end, a first leg, and a second leg;
wherein the first end of the first member is perpendicularly connected to the back side of the second member;
wherein the first leg extends from the front side of the second member in a vicinity of the first end of the said second member and has a mating protrusion on its distal end;
wherein the second leg extends from the front side of the second member in a vicinity of the second end of the said second member and has a mating protrusion on its distal end; and
wherein the mating protrusions of the first leg and the second leg of the second member mate with a surface of a side of a window frame to create a barrier between the window frame and a building structure.

2. The structure of claim 1, wherein the first member connects to the second member at the first end or second end of the second member.

3. The structure of claim 1, wherein the first member the first member is situated between the first and second ends of the second member.

4. The structure of claim 1, wherein the mating protrusions of the first leg and the second leg of the second member have hook-like endings and wherein the hook-line endings of the first and second legs of the second member mate with corresponding hook-like members of the window frame.

6. The structure of claim 1, wherein the window frame has the structure attached to more than one side of the window frame.

7. The structure of claim 1, wherein the structure is made of plastic material.

8. The structure of claim 1, wherein the structure is made of non-temperature conductive material.
